(19) United States
(12) Patent Application Publication
(10) Pub. No.: US 2017/0323015 A1
(43) Pub. Date: Nov. 9, 2017

(54) AUTOMATED METADATA CLEANUP AND DISTRIBUTION PLATFORM

(71) Applicant: DART MUSIC, INC., NASHVILLE, TN (US)

(72) Inventors: CHRIS MCMURTRY, SMYRNA, TN (US); COREY MAASS, SAUGERTIES, NY (US); JAKE HANDY, NASHVILLE, TN (US)

(21) Appl. No.: 15/586,951

(22) Filed: May 4, 2017

Related U.S. Application Data
(60) Provisional application No. 62/331,433, filed on May 4, 2016.

(51) Int. Cl. G06F 17/30; G06N 99/00; G06N 5/04

(52) U.S. Cl. CPC G06F 17/30752; G06N 5/046; G06N 99/005

(57) ABSTRACT

Example apparatuses, systems, and methods for automated data distribution and cleanup is provided. An example method includes receiving content associated with primary metadata by a processor of a content management system from a primary data storage unit, validating the content, and performing a search, of a secondary data storage unit, for data matching the content and associating secondary metadata with the content based on the search. In this regard, the primary metadata and the secondary metadata may be combined to form metadata for the content. The example method may also include performing a rule set update and formatting the metadata of the content based on the updated rule set for a distribution service. The example method may also include distributing the content with the formatted metadata to the distribution service.

### CROSS-REFERENCE TO RELATED APPLICATIONS

This application claims the benefit of U.S. Provisional Application No. 62/331,433 filed on May 4, 2016, the entire contents of which are hereby incorporated herein by reference.

### TECHNICAL FIELD

Example embodiments generally relate to data maintenance techniques and, more particularly, relate to apparatuses, systems, and methods for automated metadata cleanup and distribution.

### BACKGROUND

Collection of raw data has improved over time. However, harvesting useable information from this raw data can be more intricate. Each data point collected can be described by other data (e.g., as a form of metadata). The granularity of metadata allows for better, defined use of the information.

Many data systems are not built to accommodate complex levels of information. A good example of this is seen in the music distribution industry. Many music artists write and produce their works in order to share them with the world. For most genres of music, distribution of their product is relatively simple. However, some genres with more complex formats struggle to find resources that are both affordable and able to accept the depth of details needed to accurately catalog their work. Classical music is one of the genres that consistently encounters these barriers of distribution. In large part, the complexity associated with classical music is related to the quantity and quality of metadata needed to accurately represent a single piece of work. Errors in the processing of this data can cause a piece to be virtually invisible. Furthermore, performers are unable to adequately market their recordings, and consumers are unable to adequately locate the same recordings.

### BRIEF SUMMARY OF SOME EXAMPLES

Accordingly, some example embodiments are directed to apparatuses, systems, and methods for automated metadata cleanup and distribution. In this regard, an example method may be provided. The example method may include receiving content associated with primary metadata by a processor of a content management system from a primary data storage unit, validating the content, and performing a search, of a secondary data storage unit, for data matching the content and associating secondary metadata with the content based on the search. The primary metadata and the secondary metadata may be combined to form metadata for the content. The example method may further include performing a rule set update and formatting the metadata of the content based on the updated rule set for a distribution service. and distributing the content with the formatted metadata to the distribution service.

Another example embodiment is a system in the form of a distribution system. The example distribution system may comprise a network, at least one distribution service connected to the network, and a repository connected to the network. The repository may comprise a primary data storage unit configured to store primary metadata associated with at least a portion of content, and a secondary data storage unit configured to store secondary metadata associated with at the at least one distribution service. The example distribution system may also include a content management system connected to the network and comprising a processor. The processor may be configured to receive content associated with primary metadata from the primary data storage unit, validate the content, and perform a search, of the secondary data storage unit, for data matching the content and associating secondary metadata with the content based on the search. In this regard, the primary metadata and the secondary metadata may be combined to form metadata for the content. The processor may be further configured to perform a rule set update and format the metadata of the content based on the updated rule set for a distribution service, and distribute the content with the formatted metadata to the distribution service.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a related art music file tagging process.

FIG. 2 illustrates a general overview of an exemplary embodiment of a method of metadata collection, verification, and formatting according to the present disclosure.

FIG. 3 illustrates a network-level configuration in accordance with an exemplary embodiment of the present disclosure.

FIGS. 4A-B illustrate an exemplary embodiment of a manual operating method in accordance with the present disclosure.

FIG. 5 illustrates an exemplary embodiment of a machine-based operating method in accordance with the present disclosure.

### DETAILED DESCRIPTION

Some example embodiments now will be described more fully hereinafter with reference to the accompanying drawings, in which some, but not all, example embodiments are shown. While the making and using of various embodiments of the present invention are discussed in detail below and otherwise herein, it should be appreciated that the examples of the present invention provide many applicable inventive concepts that can be embodied in a wide variety of specific contexts. The specific embodiments discussed herein are merely illustrative of specific ways to make and use the invention and do not delimit the scope of the invention. Indeed, the examples described and pictured herein should not be construed as being limiting as to the scope, applicability, or configuration of the present disclosure. Rather, these example embodiments are provided so that this disclosure will satisfy applicable legal requirements. Like reference numerals refer to like elements throughout.

The present disclosure relates generally to apparatuses, systems, and methods associated with an automated metadata cleanup and distribution platform. According to some example embodiments, apparatuses, systems, and methods are provided for accommodating both a human-computer interface and electronic data transfer for use in an automated metadata cleanup and distribution platform. In this regard, many, artists, songwriters, labels, publishers, download services, and streaming services can't effectively audit information due to inefficient and inaccurate metadata. As such, both existing and new content, such as music, may be difficult or overly burdensome to publish and/or search. In order for a consumer to exploit music catalogs effectively, distribution of a musical work may rely on several identifying factors: artist, title, key, symphony, composer, contributors, language, syntax, punctuation, etc. Cataloging metadata associated with these aspects of musical work details consistently and accurately may ultimately enable any resource to be discovered (e.g., by cataloging and searching). Several of the above-identified problems associated with the music industry extend to additional fields which require more than a minimal amount of metadata for indexing, cataloging, and/or searching.

As such, example implementations consistent with the present disclosure may solve problems associated with traditional devices by providing apparatuses, systems, and methods for an automated metadata cleanup and distribution platform. Further, example implementations consistent with the present disclosure may be configured to use heuristic algorithms to perform at least one of collecting, validating, formatting, and distributing metadata associated with one or more sets of content. The use of conditional logic and bilateral machine learning may enable unique and efficient methods of collecting, validating, formatting, and distributing accurate and transparent data for artists, songwriters, labels, publishers, download services, and streaming services. The result can be the ability to create, maintain, and track music and data associated with the music, thereby making the music more discoverable for an end-user (e.g., listener). Artists, labels, publishers, and others are capable of being provided with information relating to both amount and timing of payments.

Some example embodiments described in the present disclosure address a plurality of issues and concerns with existing industry challenges. For example, discussed herein are novel features relating to a method of collecting, validating, formatting, and distributing data, a unique collection interface, a database for use with information relating to the method of collecting, validating, formatting, and distributing data, and particular data formatting and arrangement (also referred to as style guides) from which one or more algorithmic rules may be derived.

Various example embodiments of the present disclosure may provide apparatuses, systems, and methods for an automated metadata cleanup and distribution platform. Some example implementations consistent with the present disclosure may provide a means to collect complex layers of data in order to catalog associated metadata. In the case of classical music, larger amounts of metadata may solve issues such as consistency of formatting, linking associated movements a given symphony, displaying all the given pieces of a movement in the same place, and the like.

Some example implementations consistent with the present disclosure may make the complex process of cataloging data having at least one of hundreds of acceptable data formats possible. Dynamic decision branching techniques drive the user experience via the interface. As information is accumulated, necessary questions, and in some cases only necessary questions, need be presented in order to provide a complete cataloging of metadata related to set of content (such as an artistic work or other form of content).

Numerous other objects, features, and advantages of the present invention will be readily apparent to those skilled in the art upon a reading of the following disclosure when taken in conjunction with the accompanying drawings.

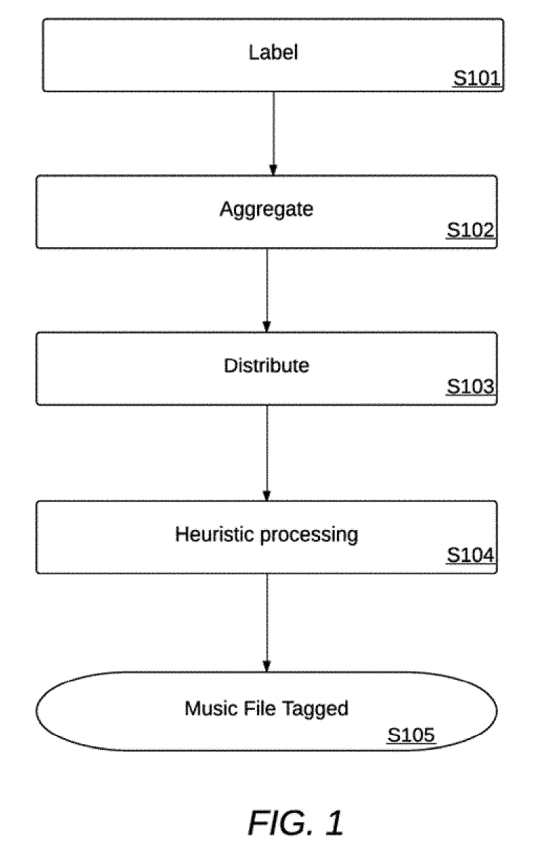

FIGS. 1-5 illustrate various exemplary apparatuses and associated methods according to the present disclosure that are described below. Where the various figures may describe embodiments sharing various common elements and features with other embodiments, similar elements and features are given the same reference numerals and redundant description thereof may be omitted below.

FIG. 1 illustrates a related art music distribution process. The traditional process may begin by manually labelling one or more music files at a step S101. The manual labelling process may be time-consuming and tiresome, as each content distributor typically has its own format and content requirements. The labeled music files may then aggregated at step S102. The aggregated music files may then distributed at step S103 to one or more content distributors based on the requirements of each of the one or more content distributors. Heuristic processing may be performed at step S104 on the distributed music files. Finally, one or more music files may be tagged at step S105. Existing processes like those illustrated by FIG. 1 can suffer from the substantial deficiencies addressed above and may be cumbersome and inefficient.

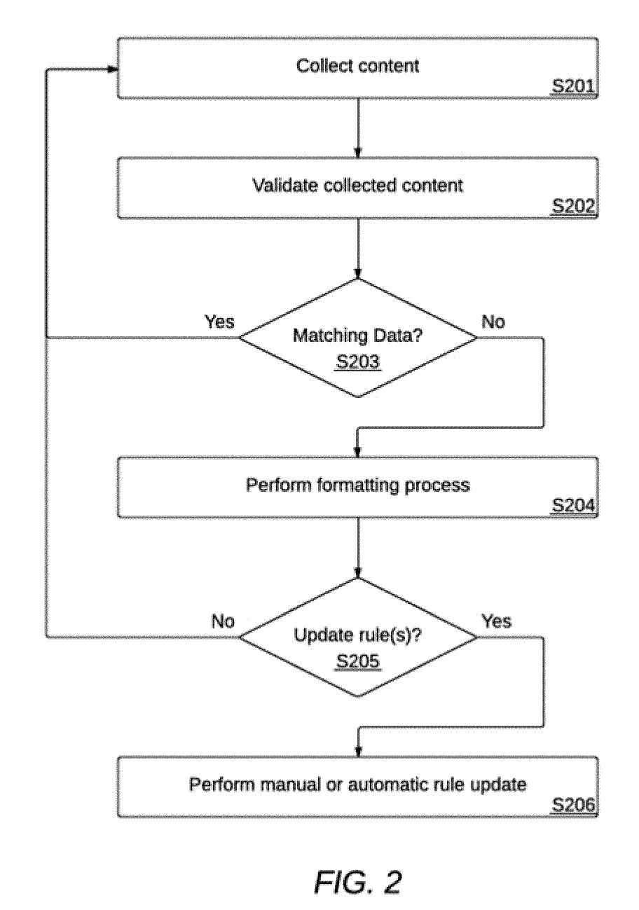

FIG. 2 illustrates a general overview of an exemplary embodiment of a method of metadata collection, verification, and formatting according to the present disclosure. The process begins at a step S201, where at least a portion of content may be collected. The content may take the form of any set of information, media, or data. After content is collected, the collected content may be validated at step S202. Validation of data may include information associated with spelling, comparison to known data, or the like. Data validated within the scope of the present disclosure extends not just to data associated with content itself, but also to metadata relating to the content and to metadata associated with a service or content provider. A user may be presented with an option to change and/or confirm one or more of content data and metadata at the step S202.

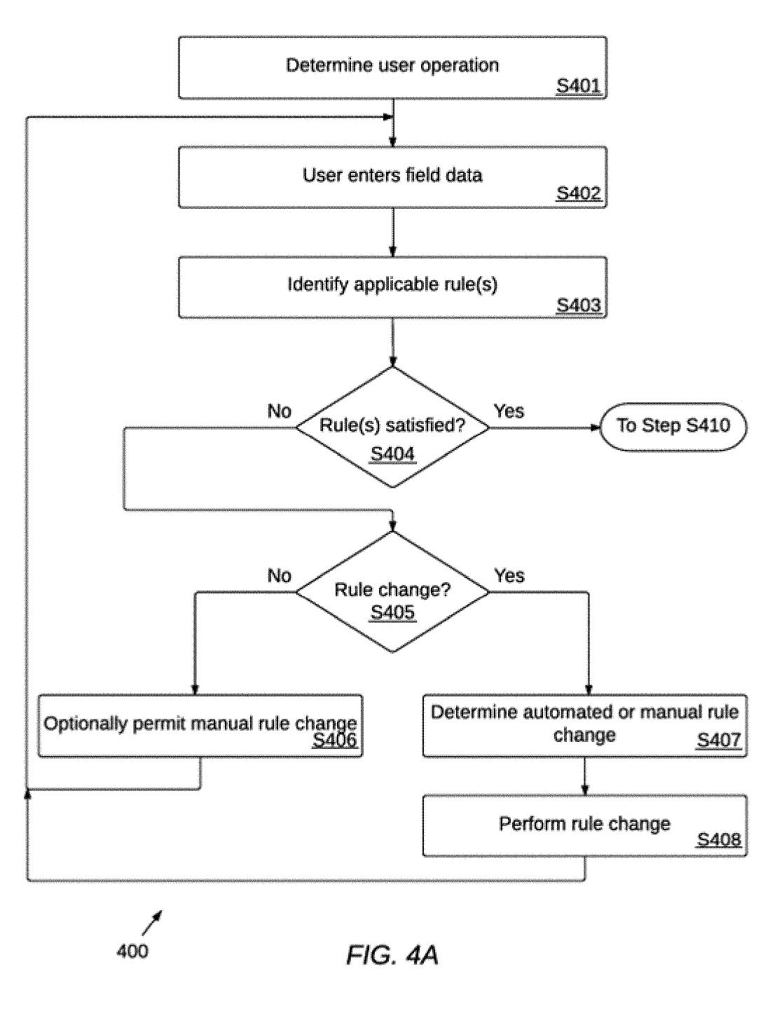

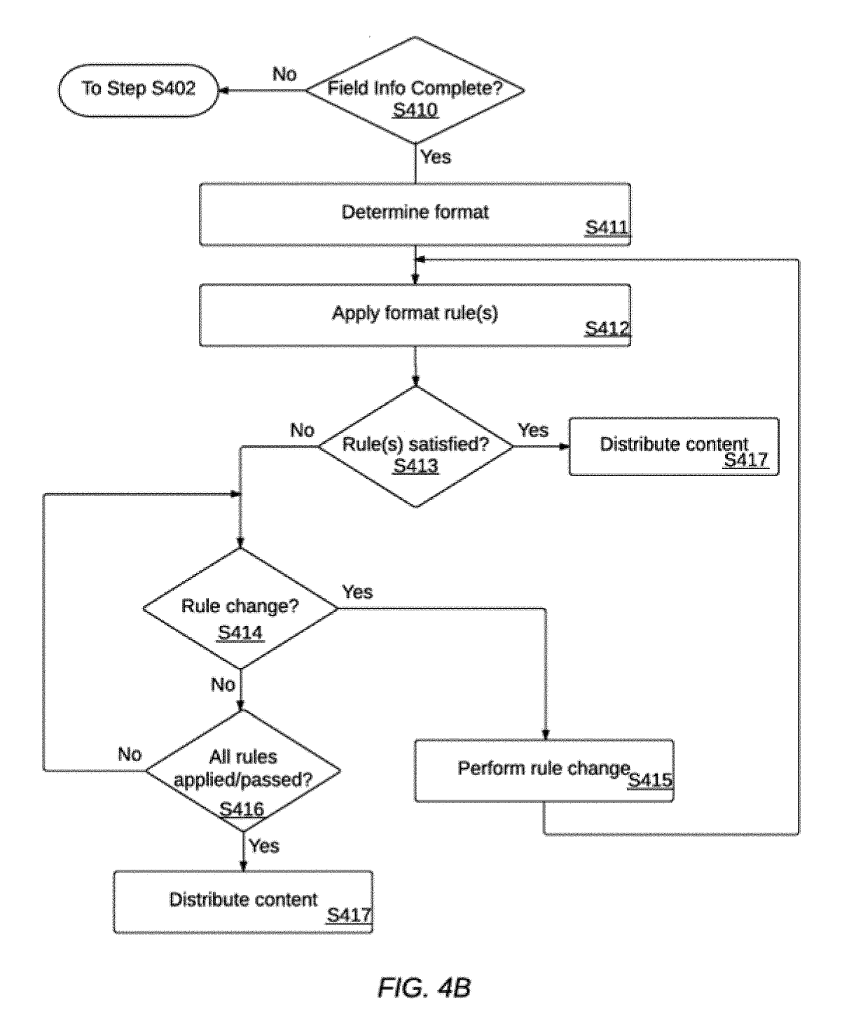

It may be determined at step S203 whether matching data exists for collected content. In one exemplary embodiment, if matching data exists, the matching data may be associated with the collected content, and the process may return to the step S201. If matching data does not exist, the process continues to step S204, where a formatting process may be performed. Formatting processes consistent with the present disclosure may comprise both manual and automated methods. Formatting methods consistent with the present disclosure (e.g., the exemplary methods illustrated by FIGS. 4A-B and 5) may be configured to use dynamic algorithms to create one or more sets of customized metadata associated with one or more requirements of a receiver (e.g., service 330).

The process illustrated by FIG. 2 continues to step S205, where it may be determined whether one or more rules should be updated. If the result of the step S205 is negative, the process may return to step S201. If one or more rules are to be changed, the process may continue to step S206, where at least one of a manual and an automatic rule update may be performed.

Implementations consistent with the present disclosure in various embodiments address accepted standards and rules of receivers of data (e.g., end users) while dynamically writing new rules generated from the behavior of aggregate generators (users). As a result, new standards and rules from which to validate and add to a repository (e.g., repository 320) may be created. Existing standards and rules may also be modified or removed within the scope of the present disclosure through the use of bilateral learning and predictive analysis.

Analysis relating to similarity and contrast between an input against a rule set and known good data points include a plurality of options and criteria. One criterion relates to a first to response approach. In particular, there may be circumstances that may cause a system to return a first response, thus relating to the reliability of the first response. A ranking system may be associated with input information based on a relative speed of return from each resource. Often, there may be multiple results and/or choices for a user. The ranking system method may, in one embodiment, have a built-in bias, for example favoring local search engine, based on faster speed as compared to search engine casting a wider net and requiring additional time. Another criterion relates to a particular input source. The point of entry of data may be useful in various embodiments to determine how information is processed and one or more assumptions made.

In one embodiment, a “time out” function may be used to determine reliability. For example, if a high ranking resource does not create a return within a predetermined time out period, the system may be configured to use a next sequential resource. Additionally or alternatively, sources may be capable of being ranked in parallel, and do not have to be sequential. By doing so, multiple return choices may be provided. Furthermore, input context sensitivity may be analyzed. For example, one or more priorities may be associated with request origination. In one embodiment, matching information may be designated as “right” information. In this context, “right” information may be associated with one or more confidence factors of scores. For example, if a descriptor is a series of words such as a title, the system may be capable of matching one or more words of the title to a known data set to result in a high confidence factor. Optionally, one or more assumptions may be made using a data entry tool which may be used to assume a user's intent, thus affecting information considered correct. Nevertheless, any information returned may be capable of being weighted in accordance with varying desired criteria.

Implementations consistent with the present disclosure may be capable of creating and maintaining vast data sets corresponding to content, to content metadata, and to service or content providers. To a large extent, a great deal of this data extends beyond a particular use. For example, a complete set of metadata relating to a particular set of content not only assists in vastly increasing a speed of content intake and reducing duplication, but also provides more complete and thorough search engine capabilities, similarity analysis, predictive capabilities, content creator payment schemes, etc.

In one embodiment, information received from a user of the system may be obtained by means of an intelligent questionnaire. The intelligent questionnaire may be configured to ask one or more questions based upon one or more sets of pre-existing data corresponding to at least one portion of content. For example, in one embodiment, field data received from a user of the system may be compared against one or more previous submissions not just associated with the portion of content itself, but also against at least one selected service (e.g., service 330). Based on examining pre-existing data, the system may be able to craft an intelligent questionnaire which reduces a quantity of information required from a user. The system permits both predictive and suggestive analysis relating to information associated with at least one of the portion of content and the selected service. Furthermore, input received in reply to the intelligent questionnaire may be used to add, modify, or remove a rule associated with at least one of the portion of content and the selected service.

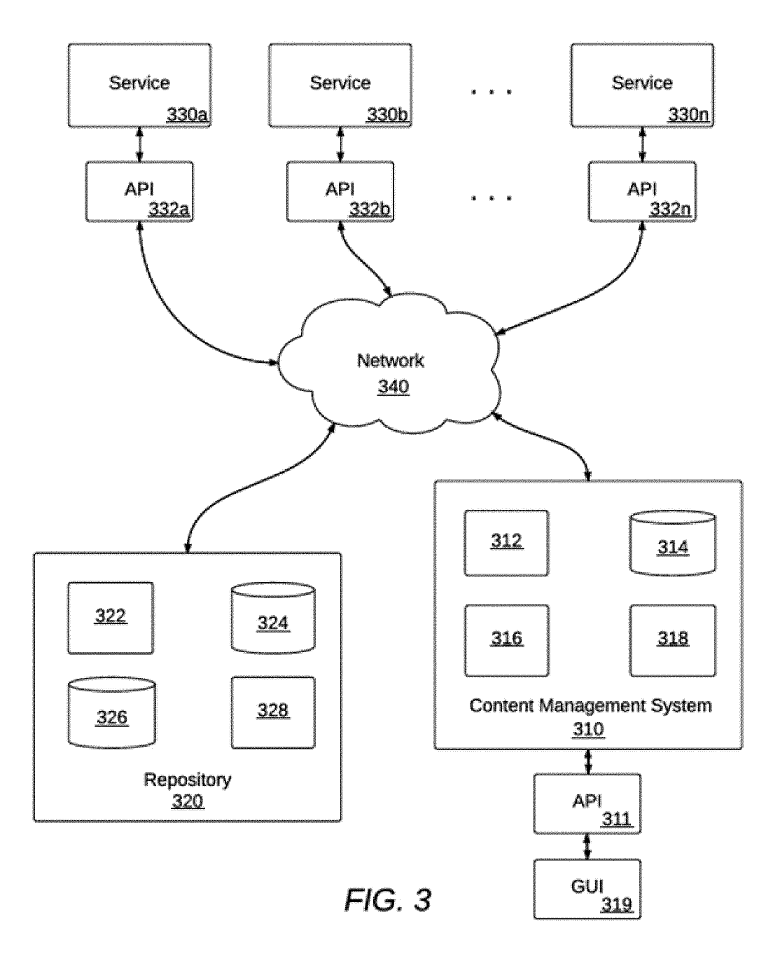

FIG. 3 illustrates a network-level configuration in accordance with an exemplary embodiment of the present disclosure. The network architecture comprises at least one of a content management system 310, repository 320, and a service 330 having an associated API 332. Each of the at least one content management system 310, repository 320, service 330, and associated API 332 are configured to be interconnected via a network 340. The content management system 310 includes one or more of a microprocessor 312, a storage unit 314, a communications unit 316, and a display unit 318. The communications unit 316 of the content management system 310 is configured to communicate with the network 340.

In one exemplary embodiment, the network 340 may include the Internet, a public network, a private network, or any other communications medium capable of conveying electronic communications. Connection between the content management system 310 and network 340 may be configured to be performed by wired interface, wireless interface, or a combination thereof, without departing from the spirit and the scope of the present disclosure. In one exemplary operation, the content management system 310 stores one or more sets of instructions in the storage unit 314, which may be configured to be executed by the microprocessor 312 to perform operations corresponding to the one or more sets of instructions. The display unit 318 may be embodied within the content management system 310 in one embodiment, and may be configured to be either wired or wirelessly-interfaced with the content management system 310.

In various exemplary embodiments, the content management system 310 may take the form of at least one of a desktop computer, a laptop computer, a smart phone, or any other electronic device capable of executing instructions. The microprocessor 312 may be configured to take the form of a generic hardware processor, a special-purpose hardware processor, or a combination thereof. In embodiments having a generic hardware processor, the generic hardware processor may be configured to be converted to a special-purpose processor by means of executing a particular algorithm for providing a specific operation or result.

The content management system 310 may be configured in various embodiments to be associated with a fixed location, but may also be capable of being transported, either during operation or while powered off. In one embodiment where the content management system 310 is a server computer, the content management system 310 may be at least temporarily located at a content manager provider's premises. In various embodiments, the content management system 310 may be configured to operate remotely, and may be configured to obtain or otherwise operate upon one or more instructions stored physically remote from the content management system 310 (e.g., via client-server communications and/or cloud-based computing).

At least one Application Programming Interface 312 may be associated with the content management system. The API 311 may be configured in one embodiment to operate in conjunction with one or more Graphical User Interface (GUI) 319. In one embodiment, the GUI 319 may be configured to take the form of an Internet-accessible webpage. Additionally or alternatively, the GUI 319 in various embodiments may take the form of a standalone application executed by at least one of content management system (e.g., as part of display unit 318), by a device remote from the content management system 310 (e.g., a user device), or any combination thereof. Although illustrated as being separate from the content management system 310, it should be appreciated that one or more of the API 311 and GUI 319 may be implemented by the content management system 310, either in whole or in part.

At least one repository 320 may be connected to the network 340 in one exemplary embodiment. The repository 320 includes at least one microprocessor 322, primary storage 324, secondary storage 326, and communications unit 328. The repository 320 may be configured to communicate with the network 340 using the communications unit 328. The repository 320 may be configured to store at least one executable instruction at a storage unit therein (e.g., at least one of the primary storage 324 and secondary storage 326), configured to cause the repository to perform one or more operations when executed by the microprocessor 322. In various embodiments, the repository 320 may be configured to operate remotely, and may be configured to obtain or otherwise operate upon one or more instructions stored physically remote from the repository 320 (e.g., via client-server communications and/or cloud-based computing).

The primary storage 324 may be configured to store at least one set of primary data. Primary data includes one or more sets of metadata associated with one or more pieces of content. For example, in one embodiment, the one or more pieces of content comprise digital audio files, and the primary data stored at the primary storage 324 comprises information relating to one or more aspects of at least one of the one or more pieces of content. In this example, information relating to one or more aspects of a digital audio file may comprise, without limitation, an artist, track name, album identifier, musician identifier, operational characteristic of the audio file or performer, classification of one or more compositional attributes or characteristics of the content, or the like. One or more sets of primary data may be associated with either existing or non-existing content. For example, one set of primary data may correspond to a hypothetical visual or audio content work without any of the content management system 310, repository 320, or service 330 having knowledge or access to the hypothetical visual or audio content work. In this example, primary data corresponding to the hypothetical work may be capable of being associated with the hypothetical work at a later time, upon recognition or ingestion of the data within the context of the present disclosure.

Primary data associated with the primary storage 324 may be stored in a number of ways within the scope of the present disclosure. Although illustrated as being stored at a single repository 320, it should be appreciated that one or more sets of primary data may be stored at a plurality of repositories 320, for example in a redundant manner. Additionally or alternatively, one or more sets of primary data may be stored in a distributed manner, for example using a cloud-based service, peer-to-peer configuration, or any other means of distributed storage capable of storing and retrieving at least a portion of primary data.

The secondary storage 326 may be configured to store at least one of secondary metadata associated with one or more pieces of content, and metadata associated with one or more service 330. Each service 330a-n illustrated in the exemplary embodiment of FIG. 3 may comprise a content provider, streaming service, or any other distributer of data or information. For example, in one exemplary embodiment, the service 330a may comprise a network-based streaming audio provider (e.g., Pandora®, Amazon Music®, etc.), service 330b may comprise a network-based streaming video provider (e.g., Netflix®, Hulu®, etc.), and service 330n may be a content marketplace (e.g., iTunes®, Android™ Play Store, etc.). Each service 330 may have its own unique content and/or formatting requirements. For example, a content format and a metadata data or format requirement associated with service 330a may be different from the same formats or requirements of service 330b. These differences may make it time-consuming and difficult to catalog, index, and format both content and metadata across multiple platforms.

Making matters difficult, content and formatting requirements associated with each service 330 may constantly be evolving, making even automated systems difficult to implement. For example, an Application Programming Interface (API) 332a associated with a service 330a may be modified by the service 330a, both without prior notice and in a significant manner which fundamentally alters operational characteristics of at least one of the service 330a and API 332a. The secondary storage 326 of repository 320 may be configured to store secondary data corresponding to secondary metadata associated with one or more pieces of content, and metadata associated with one or more service 330. For example, in one embodiment the secondary data corresponds to at least one content or formatting requirement associated with at least one of a service 330 and/or API 332. At least one of the repository 320 and content management system 310 may be configured to update, edit, or otherwise modify at least one set of secondary data associated with a service 330 or API 332.

Implementations consistent with the present disclosure may be configured to perform bilateral learning by at least one of the content management system 310 and repository 320. Bilateral learning refers to the ability for the system to intelligently learn from data moving through the system, rather than merely by manual input. For example, bilateral learning in various embodiments may take the form of discovering majority rules associated with at least one service 330, piece or type of content, or any other characteristic. No external input may be required to perform bilateral learning. Rather, in one exemplary embodiment, data within the system itself may inform the bilateral learning implementation. Put another way, the bilateral learning can be seen learning extrinsically, by examining or operating upon push or pull data that has been manipulated based on one or more standards or rules. As such, rule changes may be capable of informing the system as much as rule change instructions at the system.

In contrast to existing systems, implementations consistent with the present disclosure may, in one embodiment, be seen as implementing a parallel process, with both a closed-loop rule system and an open-loop rule system. Closed-loop rule systems include instruction-based rule changes received at the system, whereas open-loop rule systems consistent with the present disclosure include one or more machine learning aspects, such as bilateral learning. Open-loop rule systems consistent with the present disclosure include systems configured to enable rule modification at a plurality of levels. For example, rule changes in accordance with an open-loop rule system may be associated with an individual piece of content, one or more sets of primary or secondary data stored at the repository 320, or any other functional or operational characteristic associated with one or more actor or set of data used in or relating to the system.

Data stored in the primary storage 324 or secondary storage 326 may take the form of content data, metadata, or a combination of content data and metadata. In one exemplary embodiment, each of the primary storage 324 and secondary storage 326 may comprise, for example, only metadata. The metadata may correspond in one embodiment to one or more pieces of content which may or may not be associated with or exist within a content provider's network, such as a service 330. That is to say that a single portion of metadata associated with a repository 320 (e.g., stored at the primary storage 324) may relate to a single piece of content, where the single piece of content may be available from or otherwise associated with one or more of the services 330a-n. When combined with the secondary data stored at the secondary storage 326, the resulting combination of content metadata and service metadata permits proper formatting, tagging, indexing, and cataloging of one or more pieces of content associated with a particular service 330.

FIG. 4A illustrates an exemplary embodiment of a manual operating method 400 in accordance with the present disclosure. The process begins at step S401, where it may be determined that the system is operating in a manual operating mode. This determination may be made by the content management system 310 in one embodiment, for example when a manual input or indication is received at the content management system 310. The process continues to step S402, where a user associated with the GUI 319 may enter field data. Field data received at the step S402 may comprise any data, information, attribute, or characteristic associated with at least one of a piece of content and a service 330. After receiving the field data via the API 311, the content management system 310 may identify applicable rules relating to the received field data at step S403 (e.g., using a rule chart or other representation of one or more rules). Rule data may be stored, for example, by at least one of the storage unit 314 of the content management system 310, at least one of the primary storage 324 and secondary storage 326 of the repository 320, and at a location remote from at least one of the content management system 310 and repository 320. At step S404, the content management system 310 may determine whether the rules identified at step S403 are satisfied.

If it is determined at the step S404 that the identified rules are not satisfied, the process continues to step S405, where the content management system 310 determines whether a rule change should be implemented. The determination at the step S405 in one embodiment may incorporate bilateral learning to determine whether a rule change should be implemented. For example, the content management system 310 may be configured to track both conforming and non-conforming input data to determine trends or repeated successes or failures to confirm, amend, or otherwise modify at least one rule. Rule changes may be associated with an individual piece of content, a particular class or type of content or metadata, a service 330, or any other entity, configuration, or characteristic of the system.

If an automated rule change is not determined to be required at the step S405, the system may be configured to optionally permit at least one manual rule change at a step S406. The process may then return to the step S402. If a rule change is determined to be performed, the process may continue to step S407, where the content management system 310 determines whether the rule change is automated or manual. If automated, the content management system 310 may perform the rule change automatically at the step S408 and the process returns to the step S402. If manual, a user associated with the content management system 310 is permitted to indicate a rule change and/or customized field data, and the process may return to the step S402. In one exemplary embodiment, when a rule change occurs, the content management system 310 may be configured to both perform a rule change and to provide field data satisfying the rule change as part of returning to the step S402 (e.g., so as not to require re-entry of the rule-changed field data).

When it is determined at the step S404 that the identified rules are satisfied, the process may continue to step S410, illustrated at FIG. 4B, where the system may determine whether the field information is complete. If it is determined that the field information in incomplete, the process may return to the step S402. When it is determined that the field data is complete, the process continues to step S411, where the content management system 310 determines at least one of a proper content and metadata format. In one exemplary embodiment, the content and metadata format relates to at least one set of metadata stored by the secondary storage 326 of the repository 326. The format determined at the step S411 may comprise at least one format requirement or setting associated with at least one service 330. In various exemplary embodiments, if no format requirement or setting is identified at the step S411, the process may produce an error, may determine that a format should be unchanged, or may perform a default action.

The process may continue to step S412, where one or more format rules are applied (e.g., to at least a portion of content or to primary data or secondary data). The process then may continue to step S413, where the content management system 310 determines whether the rules applied at the step S412 were satisfied. If it is determined at the step S413 that the rules were not satisfied, the process may continue to step S414, where it is determined whether a rule change should be performed. If it is determined that a rule change should be implemented, the process may continue to step S415, where a rule change may be performed. The rule change in one embodiment is an automated rule change, dynamically learned and/or applied based at least in part upon bilateral learning. After the rule change is applied, the process returns to the step S412.

If it is determined that no rule change should be performed at the step S414, the process may continue to step S416, where it is determined whether all rules have been applied and passed. If it is determined at the step S416 that at least one rule has not been applied or did not pass, the process may return to the step S414. If it is determined at the step S416 that all rules have been applied and passed, the process continues to step S417, where one or more portions of content are distributed. Distribution at step S417 may take the form of transmitting one or more portions of content, for example to an API 332 associated with a service 330.

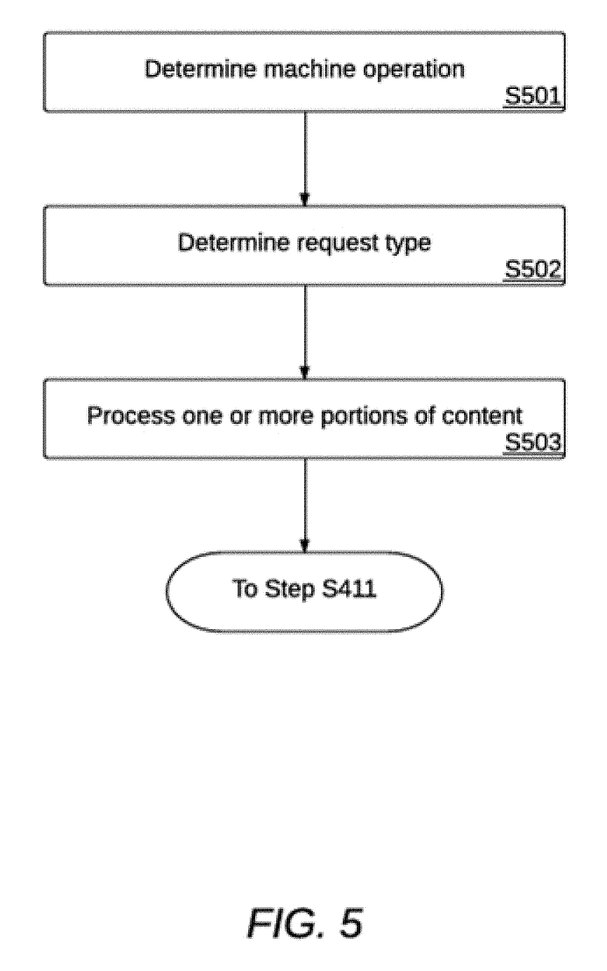

FIG. 5 illustrates an exemplary embodiment of a machine-based operating method 500 in accordance with the present disclosure. The process begins at a step S501, where it may be determined by the content management system 310 that the system is operating in the machine-based mode. The process may continue to step S502, where the content management system 310 may determine a request type associated with at least one of content and metadata. For example, in one embodiment the request type may comprise information associated with at least one of content and a particular service 330 associated with the content. The process may continue to step S503, where one or more portions of content are processed (i.e., ingested) by the system.

The method of processing (i.e., ingesting) content generally follows the process illustrated at FIG. 4B. One or more rules and/or format criteria in the machine-based method may be provided by or otherwise determined from a request type received at the step S502, information associated with at least a portion of data, or a particular service 330. The system may be configured in one exemplary embodiment to perform bulk content ingestion at the step S503. For example, a use of the content management system 310 may desire to upload 100 properly formatted items of content to the service 330b via the API 332b. In operation, at least one of the repository 320 and content management system 310, either alone or in combination, may operate to ingest a plurality of content elements, and to process the one or more pieces of content according to primary data stored in the primary storage 324 and secondary data stored in the secondary storage 326 to meet at least one format or requirement associated with the service 330b and/or API 332b.

According to some example embodiments, processing one or more portions of content consistent with the present disclosure may comprise, in one embodiment, modifying an existing data set, creating a new data set, or referencing two or more data sets within the scope of the present disclosure. Whether the processing involved modification, creation, or association, the processing is configured in one embodiment based upon at least one rule associated with a service 330. Furthermore, the operation of modification, creation, or association may be accomplished at least in part through the use of a third party storage, processor, server, or processing element, where the content management system and/or repository 320 are configured to coordinate any modification, creation, or association.

Predictive bilateral learning or associations consistent with the present disclosure may take the form of both loose couplings and absolute coupling. Loose coupling in one embodiment may comprise attributes, characteristics, or formatting predictions, edits, or modification, not based upon an absolute identifier of a particular class or instance of content. Unlike loose coupling, absolute coupling refers to aspects, characteristics, or attributes associated with a particular or uniquely identified content. For example, an absolute couple in one embodiment may take the form of a particular set of performer or composition settings for each track of a particular recording. A loose coupling in one example could take the form of a suggested or predicted data associated with a particular field data of a content file based upon a particular performer's characteristics or sound profile, or may extend for example to a genre or other attribute within the scope of the present disclosure.

By implementing bilateral learning, example implementations consistent with the present disclosure, may be capable of automatically creating, selecting, editing, and/or modifying content, metadata associated with content, metadata associated with service providers, metadata associated with one or more APIs associated with any entity of the system, or any other aspect of content or metadata. Example implementations consistent with the present disclosure may be capable in one exemplary embodiment of detecting a content format or metadata change associated with a service 330 or API 332 and performing an automated rule change as previously described responsive to a detected change. Similarly, example implementations consistent with the present disclosure may enable automated rule changes based upon repeated or detected manual modifications associated with at least one of content and a service 330 or API 332.

Numerous advantages over existing systems are provided by way of example implementations consistent with the present disclosure. In one exemplary embodiment, various aspects of the present disclosure may be used to provide properly formatted content to one or more content distributers, while also maintaining proper metadata for each of the one or more content distributors. For example, secondary data as previously described may be used to specify a content and/or metadata format associated with a streaming audio service. During content ingestion, the format may be used in conjunction with one or more digital audio content files to provide properly formatted content data to a plurality of streaming audio services, each having a unique content and/or metadata format. The formatting process of the present disclosure may be used to create predicted or suggested metadata additions, modifications, or removals based on bilateral learning, from at least one of system users, historical and current processed data, and content providers.

In one example, album data may be collected based on a database of previous releases in conjunction with a completed intelligent questionnaire. Database schema may be determined based on a streaming provider and may vary between providers. Some metadata fields may be automatically filled based upon pre-existing data from previous releases and other sources matching entered metadata. Collected album data may be validated against the same rules used to determine what data points needed to be collected. Validated album data may be configured to be packaged for and submitted to each streaming provider according to per-provider rule sets, for example, determined by previous releases. Bilateral learning consistent with the present disclosure may enable discovery of streaming provider changes if a package is rejected. The system may be capable of manually or automatically adding, modifying, or removing rules based on data moving through the system. Thus, if a package is rejected by a streaming provider, the cause may be discovered and rule(s) modified to define a package format accepted by the streaming provider.

By maintaining the primary data at the repository 320, the present disclosure may enable not just one-time metadata manipulation, but also real-time and update-based processing. For example, when a rule addition, modification, or removal is detected, previously-submitted releases for any artist or label may be scanned to determine if the change in rules affects their metadata. If yes, then the metadata may be modified to match the new rule and the previous releases may be re-submitted to one or more streaming providers to update their respective databases. In one example embodiment, this rule change detection may be implemented by (1) detecting a rule update corresponding to at least one of a collection and delivery algorithm, (2) determining whether the change affects at least one aspect of an intelligent questionnaire, and (3) if yes, a new path may be determined and, if necessary, additional questions may be added to the intelligent questionnaire.

Systems consistent with the present disclosure also permit existing content or data sets to be reviewed and/or cleaned up, for example by removing duplicates or adding keywords or tag data. For example, in the context of a book publisher and retailer, a process may begin by receiving a content identifier from the publisher. In response to receiving the content identifier, a metadata record associated with the content identifier may be modified, for example by adding additional tags based on at least one of primary data and secondary data. The publisher may then be provided with the updated data set corresponding to the content identifier. After a predetermined or variable amount of time has elapsed, the system may pull data from one or more retailers or otherwise obtain data relating to the content identified by the content identifier, along with metadata corresponding to the content. Using the pulled data, the system may be capable of determining, for example, whether a new edition of a book has been published, whether additional keywords or tags should be added, or the like. The system may then again update the data set corresponding to the content identifier and provide this information to the publisher. This process may be repeated as often and as long as desired in order to maintain current information and to clean up existing content data.

Another example of an implementation consistent with the present disclosure relates to collection societies and performing rights organizations registering the works of the songwriters and publishers they represent. The process begins when a songwriter or publisher submits a song to a performing rights organization (e.g., through a performing rights organization website using a form with conditional logic such as an intelligent questionnaire to input the necessary data). Fields of the intelligent questionnaire may be determined by use of a database of previous ingested data. A database schema in one embodiment may be determined based on one or more performing rights organizations indicating what fields are necessary. Some fields may be automatically filled based on pre-existing data from previous data and other sources that match (e.g., composer=Mozart, so title must match certain values).

Some fields may be configured to offer suggestions (e.g., auto-completion) based on pre-existing data from previous data, and other sources. Information may be obtained from the previously ingested data from other sources, if applicable. If information does not exist at the repository 320, then it may be added so that if and when that song is recorded, it pulls all of the correct songwriter and publisher info to be added to the release metadata that is sent to one or more services (e.g., service 330), so that each service knows to whom payment is required. Other metadata may also be populated (e.g., song title, location, etc.).

A performing rights organization's database may be scraped and compared to at least a portion of the repository 320. If any changes are present (e.g., the sale of a catalogue from one publisher to another, or the transfer of a catalogue to a spouse or heir after the death of a writer, change in percentage of ownership), then the repository may be updated and changes submitted to services such as content providers and others connected to the system, so that payment is submitted to the correct rights holders.

In various embodiments, a strong level of security may be placed on a publisher or performing rights organization's access to the above-described collection interface. Information may be compared to other performing rights organization and collection societies to identify conflicting information, as several writers and publishers may exist across several performing rights organizations. If a conflict is found, an exception may be submitted to the conflicting writers and publishers. A resolution may be added to the repository 320 and associated conditional logic rules until there is another conflict. In various embodiments, one or more sources associated with content may be monitored or tracked, and any conflicts may be updated and changes submitted to the one or more sources in real-time, based upon the system processing all input data, whether or not the input data was obtained from or specifically identifier the one or more sources.

Although described with numerous references to visual and audio works, it should be appreciated that the scope of the present disclosure extends to any set of data, so long as the set of data is capable of being described or referenced by means of metadata. Although illustrated as being remote from the content management system 310, one or more of the services 330a-n and corresponding APIs 332a-n may additionally or alternatively be implemented at the content management system 310, the repository 320, or any combination thereof, without departing from the spirit and the scope of the present disclosure.

The previous detailed description has been provided for the purposes of illustration and description. Thus, although there have been described particular embodiments of a new and useful invention, it is not intended that such references be construed as limitations upon the scope of this invention except as set forth in the following claims.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements or functions, it should be appreciated that different combinations of elements or functions may be provided by alternative embodiments without departing from the scope of the appended claims. In this regard, for example, different combinations of elements or functions than those explicitly described above are also contemplated as may be set forth in some of the appended claims. In cases where advantages, benefits or solutions to problems are described herein, it should be appreciated that such advantages, benefits or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A method for metadata modification, whether the metadata is associated with content, the method comprising:
receiving content associated with primary metadata by a processor of a content management system from a primary data storage unit;
validating the content;
performing a search, of a secondary data storage unit, for data matching the content and associating secondary metadata with the content based on the search, the primary metadata and the secondary metadata being combined to form metadata for the content;
performing a rule set update and formatting the metadata of the content based on the updated rule set for a distribution service; and
distributing the content with the formatted metadata to the distribution service.

2. The method of claim 1, wherein the content comprises media information including a song.

3. The method of claim 1, wherein performing the rule set update and formatting further comprises:
receiving field data, the field data being data, information, attribute, or characteristic of the content;
determining the rule set based on the field data;
updating the rule set based on the field data to form the updated rule set; and
applying the updated rule set to the metadata of the content to format the content.

4. The method of claim 3, wherein updating the rule set based on the field data comprises determining that at least one rule in the rule set is not satisfied.

5. The method of claim 3, wherein updating the rule set comprises updating the rule set using bilateral learning.

6. The method of claim 3, wherein updating the rule set comprises implementing a manual rule change.

7. The method of claim 3, further comprising determining that the field data is complete prior to applying the updated rule set.

8. The method of claim 3, further comprising determining that a rule of the updated rule set is not satisfied after applying the updated rule set.

9. The method of claim 8, further comprising performing a second rule set update to form a second updated rule set and formatting the content based on the second updated rule set.

10. The method of claim 1, wherein performing the rule set update includes adding, modifying or removing rules from the rule set.

11. A distribution system comprising:
a network;
at least one distribution service connected to the network;
a repository connected to the network, the repository comprising:
a primary data storage unit configured to store primary metadata associated with at least a portion of content; and
a secondary data storage unit configured to store secondary metadata associated with at the at least one distribution service; and
a content management system connected to the network and comprising a processor, the processor configured to:
receive content associated with primary metadata from the primary data storage unit;
validate the content;
perform a search, of the secondary data storage unit, for data matching the content and associating secondary metadata with the content based on the search, the primary metadata and the secondary metadata being combined to form metadata for the content;
perform a rule set update and format the metadata of the content based on the updated rule set for a distribution service; and
distribute the content with the formatted metadata to the distribution service.

12. The distribution system of claim 11, wherein the content comprises media information including a song.

13. The distribution system of claim 11, wherein the processor of the content management system configured to perform the rule set update and format includes being configured to:
receive field data, the field data being data, information, attribute, or characteristic of the content;
determine the rule set based on the field data;
update the rule set based on the field data to form the updated rule set; and
apply the updated rule set to the metadata of the content to format the content.

14. The distribution system of claim 13, wherein the processor of the content management system is further configured to determine that at least one rule in the rule set is not satisfied.

15. The distribution system of claim 13, wherein the processor of the content management system configured to update the rule set includes being configured to update the rule set using bilateral learning.

16. The distribution system of claim 13, wherein the processor of the content management system configured to update the rule set includes being configured to implement a manual rule change.

17. The distribution system of claim 13, wherein the processor of the content management system is further configured to determine that the field data is complete prior to applying the updated rule set.

18. The distribution system of claim 13, wherein the processor of the content management system is further configured to determine that a rule of the updated rule set is not satisfied after applying the updated rule set.

19. The distribution system of claim 18, wherein the processor of the content management system is further configured to perform a second rule set update to form a second updated rule set and formatting the content based on the second updated rule set.

20. The distribution system of claim 11, wherein the processor of the content management system configured to perform the rule set update includes being configured to add, modify or remove rules from the rule set.
